(19) United States
(12) Patent Application Publication
(10) Pub. No.: US 2008/0038510 A1
(43) Pub. Date: Feb. 14, 2008

(54) Plastic Material That Can Be Used, in Particular, for Producing Motor Vehicle Floor Pans, and Motor Vehicle Floor Pan Made With Such a Material

(75) Inventors: Philippe Perret, Mauves (FR); Patrick Bosg, Saint Barthelemy de Vals (FR)

Correspondence Address: MATTHEW R. JENKINS, ESQ., 2310 FAR HILLS BUILDING, DAYTON, OH, 45419, US

(73) Assignee: INOPLAST, ANNONAY (FR)

(21) Appl. No.: 11/574,593

(22) PCT Filed: Sep. 1, 2005
(86) PCT No.: PCT/FR05/02183

§ 371 Date: Jul. 9, 2007

(30) Foreign Application Priority Data
Sep. 2, 2004 (FR) 04 09 293

(51) Int. Cl. B32B 3/06

(52) U.S. Cl. 428/101

(57) ABSTRACT

The composite is made of a plastics material and a fabric of reinforcing fibers embedded in the plastics material. The fibers of the fabric and the plastics material are selected in such a manner that when the composite is at rest, the fibers are bonded to the plastics material, while on stress above a certain level being applied to the composite, the fibers separate from the plastics material over a certain length without breaking. The invention also relates to a motor vehicle floor made of such a composite.

The present invention relates to a plastics composite suitable in particular for making motor vehicle floors, and it also relates to a motor vehicle floor made with such a composite.

Motor vehicle floors are already known that are made of shield molded compound (SMC), i.e. of thermosetting plastics material having reinforcing fibers such as glass fibers mixed therewith.

In particular, this composite is used for making rear floors that include a housing for a spare wheel and that leave a passage for a fuel filler tube running from a filler hatch to a fuel tank.

Until now, such a floor has been considered as being strong enough to be capable of withstanding rear impacts without leading to severe damage to its immediate surroundings, and in particular to the above-mentioned fuel filler tube.

However, new safety requirements are regularly being put forward, and there exists a need for a floor that provides even better guarantees in the event of a rear impact. More precisely, it would be advantageous to have available a floor that, in the event of the rear of the vehicle being crushed as a result of an impact, deforms without excessively damaging the fastenings that hold it to its support, so as to remain within the housing provided to receive it, and without breaking and forming sharp edges, these two criteria representing the need to avoid closing off or sectioning the fuel filler tube.

FIG. 2 shows a prior art floor 10 made of SMC after a rear impact to the vehicle, e.g. an impact at 80 kilometers per hour (km/h). It can be seen that the floor has broken at certain locations, referred to as ruptures 11, that form sharp edges 15.

A vehicle floor is also required to prevent flames from passing into the cabin, even after it has been damaged as a result of an impact. For this purpose, the floor must not present any through openings or cracks via which flames could pass.

In FIG. 2, it can be seen that the ruptures 11 could pass flames generated after the impact.

FIGS. 4 and 5 are diagrammatic sections of the composite constituting the floor, at the scale of a fiber 13 embedded in a plastics material 14.

In FIG. 4, prior to the impact, the composite is intact, whereas in FIG. 5, after the impact, a rupture 11 has appeared.

Thermoplastics composites are also known that are reinforced with reinforcing fiber fabric. Because of the fiber fabric that gives such composites good mechanical stability, they constitute, a priori, good candidates for fabricating parts that need to be able to withstand large amounts of deformation without breaking. However, experience is disappointing since the deformation to a floor induced by a rear impact on a vehicle leads to rupturing of the floor that is unacceptable because the rupturing can allow flames to pass into the cabin.

The inventors behind the present invention have sought to characterize a new material capable of satisfying the above-specified objectives without it being necessary to design a new shape for the floor.

Thus, the invention proposes a plastics composite that retains its rigidity properties that are essential for it to be used as the material constituting a floor, while being better at deforming without rupturing, e.g. coming close to the behavior of a steel sheet.

This composite is made up of a plastics material and a fabric of reinforcing fibers embedded in the plastics material, the composite being characterized by the fact that the fibers of the fabric and the plastics material are selected in such a manner that when the composite is at rest, the fibers are bonded to the plastics material, and that on stress above a certain level being applied to the composite, the fibers separate from the plastics material over a certain length, without breaking.

Surprisingly, the inventors have found that to make the composite less brittle, but still as rigid as before, it is not sufficient to reinforce it with a fabric of reinforcing fibers.

On the contrary, the difficulty to be overcome lies in obtaining a composite having properties that are, a priori, contradictory, specifically good rigidity and also the ability to fold under certain levels of stress.

After performing numerous tests, the inventors have finally identified, a posteriori, the characteristic that enables the desired, but apparently contradictory, properties to be obtained for the composite. When the composite is heavily stressed, the fibers of the reinforcing fabric must be capable of lengthening in order to conserve the unity of the composite, but without the local stresses that act on the fibers leading to the fibers breaking.

Consequently, by ensuring that in the event of a high level of local stress on the composite, a non-negligible length of fiber releases from the plastics material on either side of the stressed zone, the fibers can elongate over the length that has been released and can follow the deformation imposed on the composite.

In other words, the invention amounts to releasing the fibers in such a manner as to reduce the extent to which they are elongated, thus avoiding breaking them.

Thus, a composite of the invention is obtained by selecting the plastics material and the reinforcing fibers in such a manner that, initially, the fibers are embedded in the plastics material and are securely held therein, so as to ensure the mechanical strength of the composite up to a certain level of stress, and subsequently, if a particularly high level of local stress occurs, the fibers separate from the plastics material and can become elongated. Separation of the fibers is also referred to as “delamination”.

According to another advantageous characteristics of the invention that can be used singly or in combination:
the fibers of the fabric are fibers that have been subjected to treatment by sizing;
the fabric of fibers is embedded in the plastics material by calandering during fabrication;
the composite includes cut fibers embedded in the plastics material in addition to the fiber fabric;
the composite includes additives such as dyes, setting agents, catalysts, or inhibitors;
the fibers are selected from glass fibers, organic fibers, and metal fibers;
the plastics material is a thermosetting material, e.g. polyester;
the plastics material is a thermoplastic material, e.g. polypropylene;
the weight of the fabric lies in the range 200 grams per square meter (g/m²) to 800 g/m²; and
the composite comprises 10% to 50% fibers and 10% to 50% plastics material.

The invention also provides a motor vehicle floor characterized in that it is made of a composite of the invention.

Optionally, the motor vehicle floor of the invention includes the composite of the invention only in zones that are liable to be stressed during an impact.

The invention can be better understood on reading the following description given purely by way of example and made with reference to the accompanying drawings, in which:

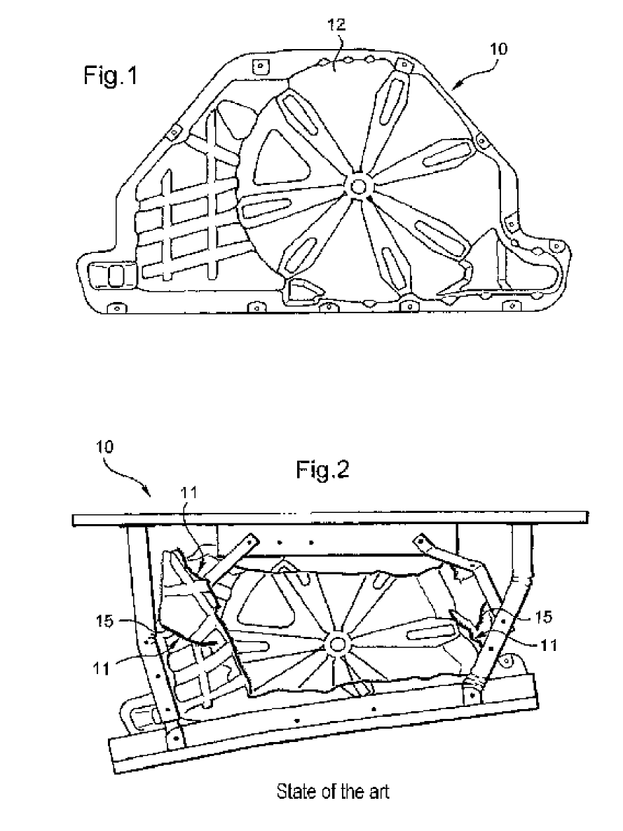

FIG. 1 is a face view of a motor vehicle floor made of a composite constituting an embodiment of the invention;

FIG. 2, described above, is a view similar to FIG. 1, showing a prior art motor vehicle floor deformed as a result of an impact;

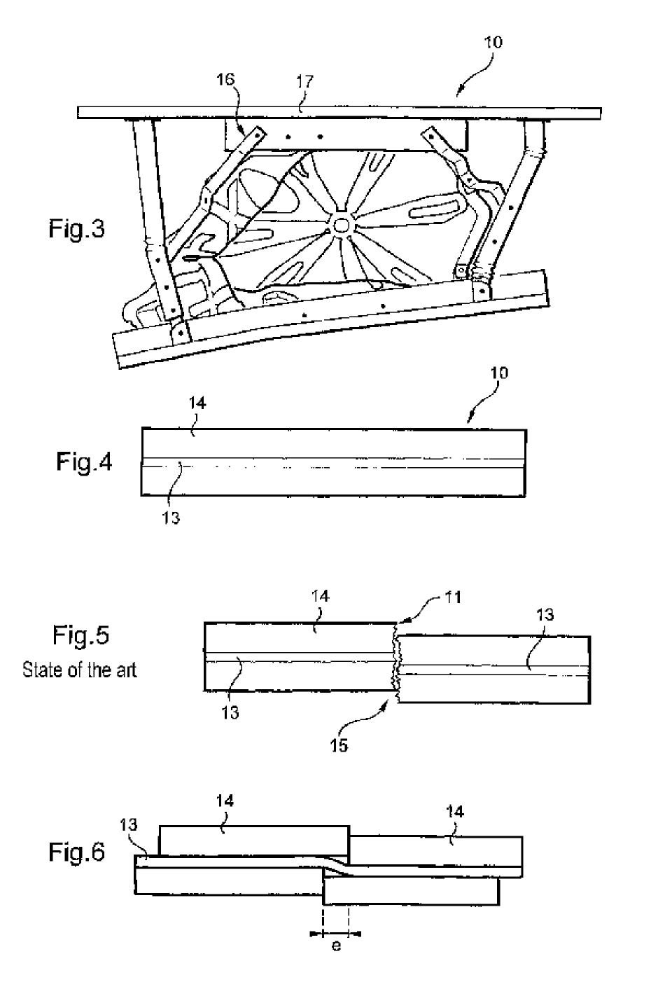

FIG. 3 is a view similar to FIG. 2 showing the floor of FIG. 1 deformed as a result of an impact;

FIG. 4, described above, is a diagram of a section through a composite including a fiber embedded in plastics material;

FIG. 5, described above, is a view similar to FIG. 4 of prior art composite following an impact;

FIG. 6 is a view similar to FIG. 5 showing a composite constituting an embodiment invention, and deformed as a result of an impact;

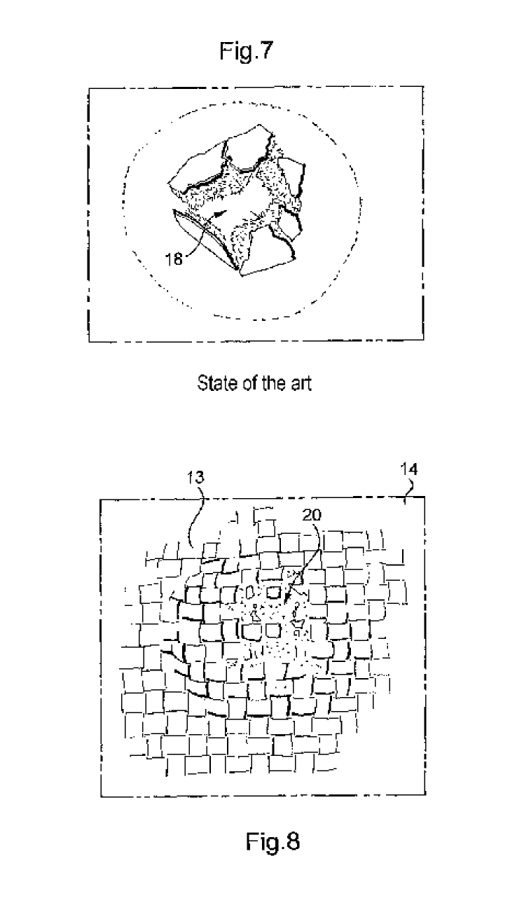

FIG. 7 is a face view of the prior-art composite of FIG. 5 after being subjected to an impact by punching; and

FIG. 8 is a view similar to FIG. 7 of the composite of FIG. 6 after being subjected to an impact by punching.

FIG. 1 shows a motor vehicle floor, given overall reference 10.

The floor 10 is of the shape that is adapted to be arranged at the rear of the motor vehicle, and in particular it includes a housing 12 for a spare wheel.

In order to have a floor that presents good behavior on impact, the floor 10 is made of a composite constituting an embodiment of the invention, i.e. a composite in which the fibers of the fabric and the plastics material are selected so that when the composite is at rest, the fibers are secured to the plastics material, while on stress above a certain level being applied to the composite, the fibers separate from the plastics material over a certain length, but without breaking.

As can be seen in FIG. 6, at the scale of the fiber 13, in the region of the stress, the fiber 13 releases itself from the plastics material over a length e, so that it can lengthen locally and deform without breaking.

The reinforcing fibers 13 are arranged in a fiber fabric embedded in the plastics material 14.

Thus, in the event of an impact to the rear of the vehicle, the floor 10 made of this composite deforms without breaking, since the fibers 13 do not break, so they maintain the cohesion of the plastics material 14 around the stressed zones.

FIG. 3 shows an example of the deformation to the floor 10 of the invention after an impact, e.g. an impact at 80 km/h. It should be observed that it does not have any ruptures forming sharp edges, and that it comprises merely zones of deformation without rupture.

It should also be observed that this floor 10 deforms without greatly damaging the fastenings 16 that hold it to a support 17.

In order to obtain a composite having these properties, the fibers 13 of the fabric, which fibers are preferably selected from glass fibers, organic fibers, or metal fibers, are subjected to a sizing treatment. The fiber fabric 13, of weight generally lying in the range 200 g/m² to 800 g/m² (preferably 546 g/m²), is subsequently embedded in the plastics material by calandering. The plastics material 14 may be a thermoplastic material, such as polypropylene for example, or it may be a thermosetting material, such as polyester for example.

In general, the composite has 10% to 50% fibers (preferably 29%) and 10% to 50% plastics material (preferably 41%).

Optionally, in addition to the fiber fabric, the composite includes additional fibers that are cut and embedded in the plastics material. These additional fibers have a reinforcing effect on the composite.

In general, the composite includes additives, such as dyes or substances used in the design of the composite, such as setting agents and catalysts or inhibitors. Where appropriate, the composite includes less than 16% of these additives, and preferably less than 8%.

The composite may also include 0 to 60% of mineral fillers, and preferably includes 22%.

Reference is made to FIGS. 7 and 8 for comparing the behavior of a prior art composite (FIG. 7) and a composite constituting an embodiment of the invention (FIG. 8), when subjected to punching.

It can be seen that the prior art composite is broken in a zone 18 that corresponds to the impact (see FIG. 7). All the energy of the impact is concentrated in this small zone 18, thus leading to the composite rupturing. The composite is thus not adapted to satisfying the requirements of specifications for a motor vehicle floor, since it would allow flames to pass through rupture zones.

In contrast, with a composite constituting an embodiment of the invention, the energy of the impact extends over a zone 20 that is larger (see FIG. 8). As a result of the impact, the fibers 13 are released from the plastics material over the zone 20 and can thus deform instead of rupturing together with the plastics material 14. The composite thus does not present rupture zones and it is more suitable for use in the design of a motor vehicle floor 10.

It should be observed, that for reasons of economy, the floor 10 may include the composite of the invention solely in those zones that are liable to suffer most in the event of an impact. The remainder of the floor 10 is then made of a conventional material.

Naturally, the invention is not limited to the embodiment described above. In particular, the composite of the invention could be used for designing other structural parts of a motor vehicle that are required to satisfy specifications that are equivalent to those described above pertaining to the floor of a motor vehicle.

1. A composite made up of a plastics material and a fabric of reinforcing fibers embedded in the plastics material, the composite being characterized by the fact that the fibers of the fabric and the plastics material are selected in such a manner that when the composite is at rest, the fibers are bonded to the plastics material, and that on stress above a certain level being applied to the composite, the fibers separate from the plastics material over a certain length, without breaking.

2. The composite according to claim 1, in which the fibers of the fabric are fibers that have been subjected to treatment by sizing.

3. The composite according to claim 1, in which the fabric of fibers is embedded in the plastics material by calendering during fabrication.

4. The composite according to claim 1, including cut fibers embedded in the plastics material in addition to the fiber fabric.

5. The composite according to claim 1, including additives such as dyes, setting agents, catalysts, or inhibitors.

6. The composite according to claim 1, in which the fibers are selected from glass fibers, organic fibers, or metal fibers.

7. The composite according to claim 1, in which the plastics material is a thermosetting material.

8. The composite according to claim 1, in which the plastics material is a thermoplastic material, e.g. polypropylene.

9. The composite according to claim 1, in which the weight of the fabric lies in the range 200 g/m² to 800 g/m².

10. The composite according to claim 1, comprising 10% to 50% fibers and 10% to 50% plastics material.

11. The motor vehicle floor, characterized in that it is made of a composite according to claim 1.

12. The motor vehicle floor according to claim 11, comprising the composite only in zones that are likely to be stressed in the event of an impact.
